(19) United States
(12) Patent Application Publication
(10) Pub. No.: US 2006/0089178 A1
(43) Pub. Date: Apr. 27, 2006

(54) Cordless telephone set

(75) Inventors: Tohru Sakata, Ogohri-shi (JP); Toshiya Sakai, Onojo-shi (JP); Mitsuhiro Haraguchi, Onojo-shi (JP); Kazumasa Yamamoto, Fukuoka-shi (JP); Atsushi Yamashita, Chikushino-shi (JP)

Correspondence Address: STEVENS, DAVIS, MILLER & MOSHER, LLP, 1615 L. STREET N.W., SUITE 850, WASHINGTON, DC, 20036, US

(73) Assignee: MATSUSHITA ELECTRIC INDUSTRIAL CO., LTD., Osaka (JP)

(21) Appl. No.: 11/248,588

(22) Filed: Oct. 13, 2005

(30) Foreign Application Priority Data
Oct. 14, 2004 (JP) P. 2004-299894

(51) Int. Cl. H04B 1/38

(52) U.S. Cl. 455/573

(57) ABSTRACT

A cordless telephone set includes a charger base and a telephone apparatus. A concave retaining section of the charger base has an inclined surface and an open section. A power feeding terminal for supplying power with a charging terminal of the telephone apparatus is provided on a lower part of the inclined surface of the concave retaining section. A positioning member for restraining the telephone apparatus is provided at the lower part of the concave retaining section. A first distance between a support point at which the positioning member supports the telephone apparatus and a center of gravity of the telephone apparatus is in a positional relationship greater by a plurality of times than a second distance between the support point and a contact point where the charging terminal of the telephone apparatus is brought into contact with the power feeding terminal.

### BACKGROUND OF THE INVENTION

The present invention relates to a cordless telephone set composed of a charger base having a power feeding function and a telephone apparatus to be mounted on the charger base.

In line with recent downsizing of mobile phone handsets and cordless telephones and lightening of the weight thereof, defective contact between a power feeding terminal of a charger base and a charging terminal of the mobile phone handsets or cordless telephones occurs. In order to prevent such defective contact, a battery incorporated in a mobile phone handset and a cordless telephone set is charged in a state where the telephone set is vertically stand as in a charger described in, for example, JP-A-2000-134808. By vertically standing the telephone set, the weight of the telephone set is utilized for a contact load between the charging terminal at the bottom surface of the telephone set and the power feeding terminal of the charger

In addition thereto, as in a charger described in JP-A-2002-335635, such a type has been known, in which a telephone set is retained in the charger body with slight inclination and is charged in such a state. As shown in FIG. 12, in a charger holder 11 for an electronic device, which is described in JP-A-2002-335635, a recessed section 13 for acceptance of a telephone set in a charger body 14 is formed, and a power feeding terminal 15 is projected from a slit 17, which is secured on the rearward inner wall surface 13a of the recessed section 13, toward the inside of the recessed section 13. The forward inner wall surface 13b is formed to be roughly vertical with respect to the rearward inner wall surface 13a, and a rib 19 is provided on the surface of the forward inner wall surface in the vertical direction so as to protrude toward the inside of the recessed section 13. The inclination angle of the rib 19 is made substantially equal to the inclination angle of the rearward inner wall surface 13a. Therefore, the telephone set 12 accommodated in the recessed section 13 is stably retained in a slightly upward inclined state, so that a stabilized charging state can be secured.

However, since the recessed section 13 of the charger holder 11 for an electronic devices, which is described in JP-A-2002-335635, is shaped so as to retain only the lower end of a telephone set 12, a user is required to check the position of the insertion inlet of the telephone set 12 into the recessed section 13 without fail and to insert the lower end of the telephone set 12 into the recessed section 13. Further, when the user takes the telephone set 12 for use, unless the telephone set 12 is once lifted from the recessed section 13, it is otherwise impossible to take the telephone set 12 out. This is not convenient for use.

### SUMMARY OF THE INVENTION

It is therefore an object of the present invention to make it easy to place and remove a cordless telephone set while securing a stabilized charging state of the telephone set.

A cordless telephone set according to the present invention is composed of a charger base having a power feeding function and a telephone apparatus to be mounted in a concave retaining section formed on the charger base. The concave retaining section includes an inclined surface for supporting the telephone apparatus and an open section that opens across the entire surface at the front side of the inclined surface. A positioning member for restraining the telephone apparatus is provided at a lower part of the concave retaining section so that the positions of respective charging terminals provided at the telephone apparatus are stabilized with regard to the power feeding terminals provided at the lower part of the inclined surface.

With a cordless telephone set according to the present invention, since the entire front surface of the concave retaining section of the charger base opens across the entire surface at the front side of the inclined surface, it is possible to easily place the telephone set on the charger base from the front side of the concave retaining section of the charger base. Also, since the telephone apparatus is fixed by the positioning member provided at the lower part of the concave retaining section so that the power feeding terminals provided at the inclined surface and the charging terminals provided at the telephone set are not separated from each other, a stabilized charging state can be secured. In addition, when using the telephone set, since the telephone apparatus can be taken out from the opening section in the front surface direction without any special operation, it becomes easy to take out the telephone apparatus

### BRIEF DESCRIPTION OF THE DRAWINGS

The above objects and advantages of the present invention will become more apparent by describing in detail preferred exemplary embodiments thereof with reference to the accompanying drawings, wherein:

FIG. 1 is a perspective view depicting a cordless telephone set according to a first embodiment of the present invention;

FIG. 2 is a sectional view taken along the line A-A in FIG. 1;

FIG. 3A is a perspective view depicting a telephone apparatus, and FIG. 38 is a rear elevational view depicting the telephone apparatus;

FIG. 4 is a sectional view depicting a state where the telephone apparatus is placed in its charger base;

FIG. 5 is a view depicting the relationship between the charger base and the telephone apparatus;

FIG. 6 is a sectional view depicting a state where the telephone apparatus is placed on the charger base;

FIG. 7 is a perspective view depicting the telephone set;

FIG. 8 is a sectional view depicting a state where the telephone apparatus is placed on the charger base;

FIG. 9 is a perspective view depicting the concave retaining section of the charger base according to a second embodiment of the present invention;

FIG. 10 is a perspective view depicting the telephone apparatus;

FIG. I1 is view depicting a state where the charging terminal is provided at the front side of the telephone apparatus; and

FIG. 12 is a sectional view depicting a related charger base.

### DETAILED DESCRIPTION OF THE PREFERRED EMBODIMENTS

### First Embodiment

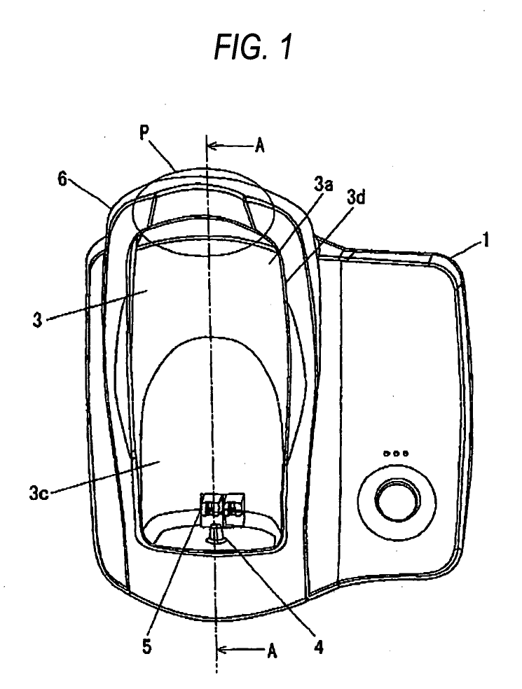

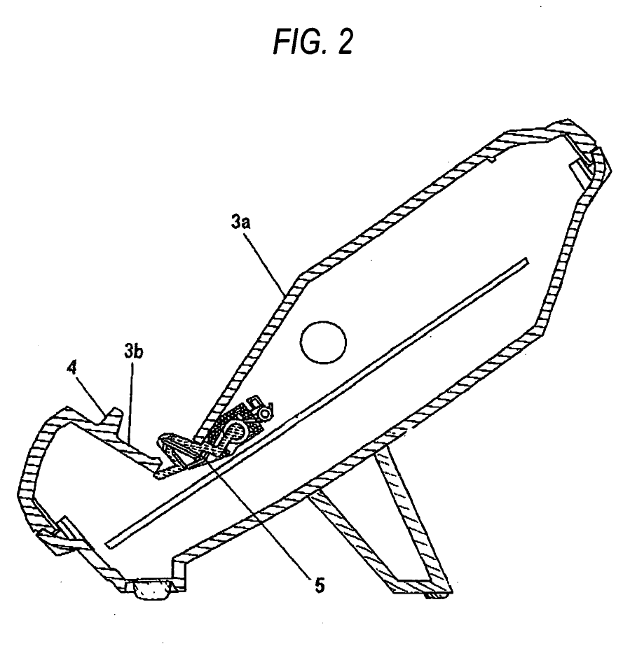

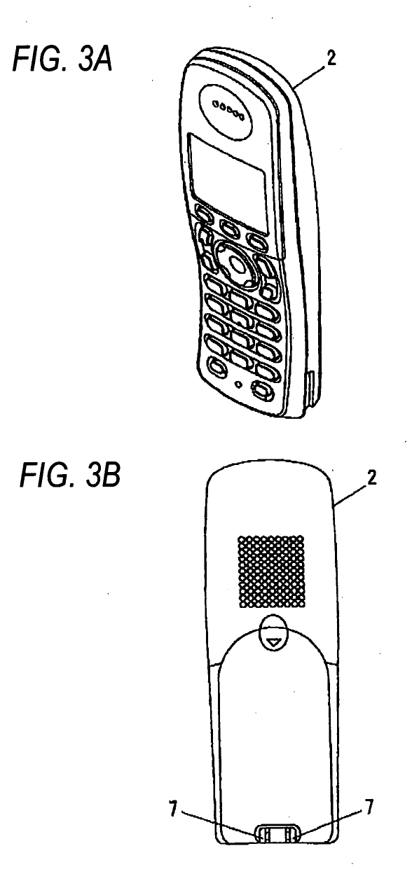

FIG. 1 is a perspective view depicting a cordless telephone set according to the first embodiment of the present invention. FIG. 2 is a sectional view taken along the line A-A of FIG. 1. FIG. 3A is a perspective view depicting the cordless telephone apparatus, and FIG. 3B is a rear elevational view depicting the cordless telephone apparatus.

As shown in FIG. 1 through FIG. 3, a cordless telephone set according to the first embodiment of the present invention is composed of a charger base 1 and a telephone apparatus 2. A concave retaining section 3 in which the telephone apparatus 2 is placed is provided at the front side of the charger base 1. The concave retaining section 3 includes an inclined surface 3a having a curved surface corresponding to the shape of the telephone apparatus 2, a bottom surface 3b having almost the same shape as the bottom surface of the telephone apparatus 2, and a side surface 3c that retains the telephone apparatus 2 at both sides thereof. The front surface of the concave retaining section 3 is made into an opening section 3d open across the entire surface thereof. In addition, the inclined surface 3a has an inclination angle at which the telephone apparatus 2 can slip down by its own-weight, taking into consideration the push-out load of the power feeding terminal and friction with the inclined surface of the concave retaining section. Further, a grille 6 for supporting the upper rear part of the telephone apparatus 2 is connected to the upper edge part of the opening section 3d. The grille 6 is brought into contact with the telephone apparatus 2 only at the part P in FIG. 1, and the part P is shaped so as to match the shape of the rear side of the telephone apparatus 2. In the first embodiment, although the grille 6 is constructed to be molded separately from the charger base 1, the grille 6 may be molded integral with the charger base 1. A projection 4 that positions the telephone apparatus 2 is provided at the bottom surface 3b of the concave retaining section 3, and a power feeding terminal 5 is projected from a slit provided at the inclined section 3a of the concave retaining section 3. The power feeding terminal 5 is slidable in the direction along which the telephone apparatus 2 slips down, that is, in the vertical direction of the concave retaining section 3.

As shown in FIG. 3, the telephone apparatus 2 has a profile in which its front surface is plain and its rear surface has a curved surface and is roughly semi-columnar. A recessed section is provided at the lower end part of the rear surface, and the recessed section is provided with a charging terminal 7 positioned so as to correspond to the power feeding terminal 5 of the above described charger base 1. Further, a recessed section (not shown) corresponding to the shape of the projection 4 of the charger base 1 is formed on the bottom surface. When the telephone apparatus 2 is placed on the charger base 1, the projection 4 is fitted in the recessed section so that the telephone apparatus 2 is positioned in the forward and rearward direction.

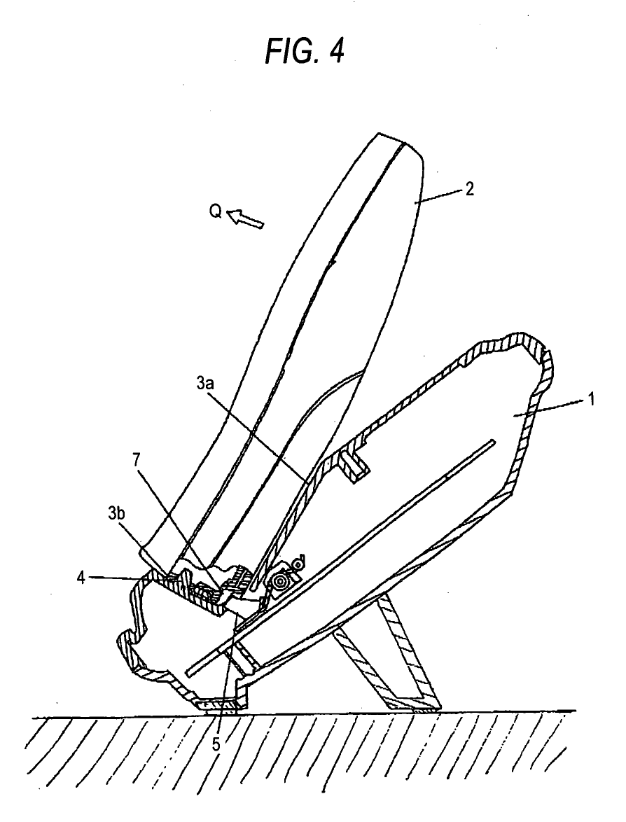

Next, a description is given of placing the telephone apparatus 2 on the charger base 1 and removal thereof, using the drawing. FIG. 4 is a sectional view depicting a state where the telephone apparatus 2 is placed on the charger base 1.

When the telephone apparatus 2 is placed on the charger base 1, if the lower end of the telephone apparatus 2 is fitted to the inclined surface 3a of the concave retaining section 3, and the telephone apparatus 2 is in the concave retaining section 3, the telephone apparatus 2 slips down along the concave retaining section 3 due to its own-weight. When the telephone apparatus 2 slips down to the bottom surface 3b of the concave retaining section 3 while sliding on the power feeding terminal 5, the recessed section provided at the bottom surface of the telephone apparatus 2 is engaged with the projection 4 provided on the bottom surface 3b of the concave retaining section 3. As shown in FIG. 4, the telephone apparatus 2 is fixed at a position where the charging terminal 7 is not separated from the power feeding terminal 5.

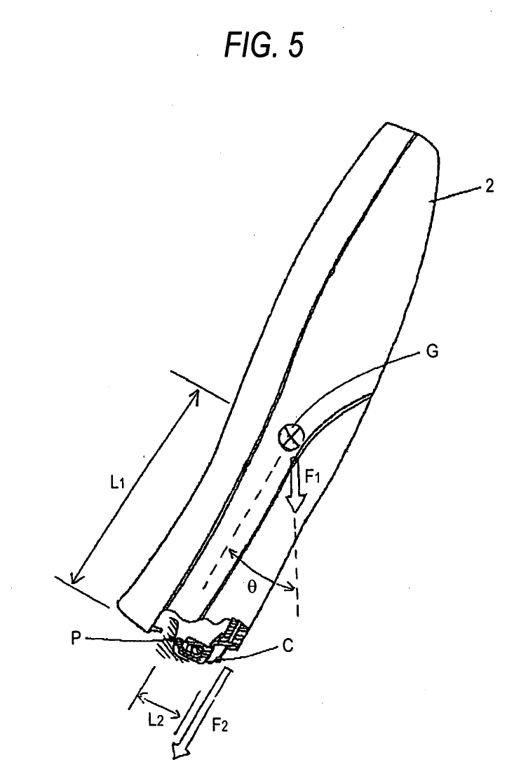

FIG. 5 is a view depicting the relationship between the charger base 1 and the telephone apparatus 2. As shown in FIG. 5, the center of gravity of the telephone apparatus 2 is positioned at a point deviated slightly downward from the middle of the device. Hereinafter, it is assumed that the point of the center of gravity is a gravity point G, a point supported by the projection 4 is a support point P, and a point at which the charging terminal 7 is brought into contact with the power feeding terminal 5 is a contact point C. The telephone apparatus 2 is placed in the charger base 1 in a posture inclined rearward, and the gravity point G of the telephone apparatus 2 is brought further rearward of the support point P and the contact point C, that is, closer to the charger base 1.

Therefore, the gravity applied to the telephone apparatus 2 operates so as to turn the telephone apparatus 2 centering around the support point P where the telephone apparatus 2 is supported by the projection 4. For convenience of description, where it is assumed that gravitation Fl is applied only to the gravity point G of the telephone apparatus 2, a force F2 at the contact point C becomes greater by several times than the gravitation Fl based on a kind of leverage principle, a force by which the charging terminal 7 pushes the power feeding terminal 5 is increased.

Herein, where it is assumed that the distance between the support point P of the telephone apparatus 2 and the gravity point G is L1, the distance between the support point P and the contact point C is L2, and the angle, which is formed by the line connecting the support point P to the gravity point G when the telephone apparatus 2 is placed, and the perpendicular line, is 0. A force F2 of the telephone apparatus 2 that attempts to turn at the contact point C centering around the projection 4 and a force Fl applied onto the gravity point G are approximately in a relationship about L1/L2.

In the this embodiment, L1 is 60 mm, L2 is 12 mm, and angle θ is approximately 30 degrees. In this case, F2 is increased by approximately 3 to 4 times the force F1.

With the construction, a user only fits the lower end of the telephone apparatus 2 to the inclined surface 3a of the concave retaining section 3 and leaves it to the concave retaining section 3. Then, the telephone apparatus 2 slips down as it is and is retained in the concave retaining section 3. Therefore, there is no need for the user to insert and place the telephone apparatus 2 in a chargeable position while checking the position of the opening section 3d of the concave retaining section of the cordless telephone set. That is, it is possible to easily place the telephone apparatus 2 in the charger base 1. In addition, since the telephone apparatus 2 is fixed at a position where the charging terminal 7 is not separated from the power feeding terminal 5, the charging terminal 7 of the telephone apparatus 2 is able to secure a predetermined contact load with respect to the power feeding terminal 5 of the concave retaining section 3, and the telephone apparatus 2 is able to keep a stabilized charging state. Furthermore, since the slipping-down direction of the telephone apparatus 2 is coincident with the direction along which the power feeding terminal 5 slides, cleaning ability of both the terminals at the contact portions thereof can be improved, wherein the charging performance can be improved.

Also, when the user takes the telephone apparatus 2 from the charger base 1, the user only holds the upper part of the telephone apparatus 2 and pulls it out from the opening section 3d in the front surface direction (Q in FIG. 4) of the charger base, since the projection 4 provided on the bottom surface 3b of the concave retaining section 3 can be easily disengaged from the recessed section provided on the bottom surface of the telephone apparatus 2. It is possible to smoothly take out the telephone apparatus 2. Thus, with a cordless telephone set according to the first embodiment of the present invention, it is possible to improve the convenience in use both when charging the telephone set and when using the same.

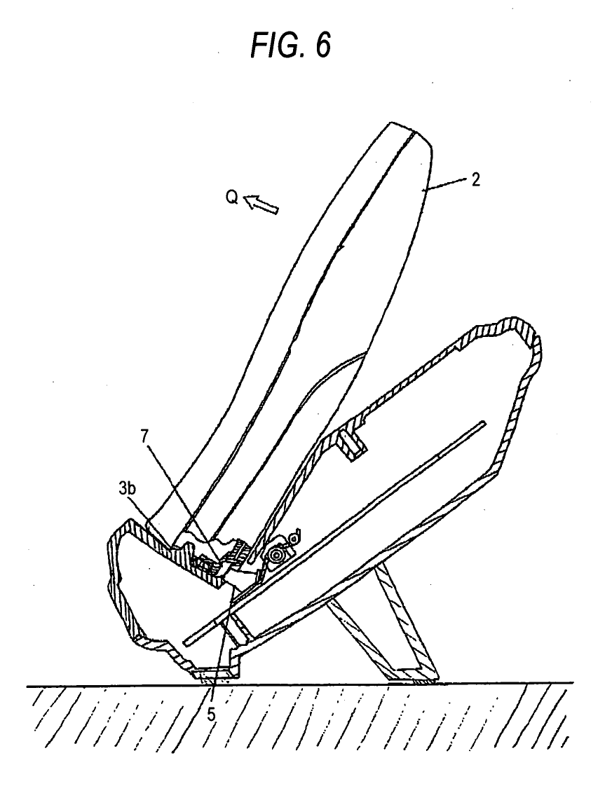

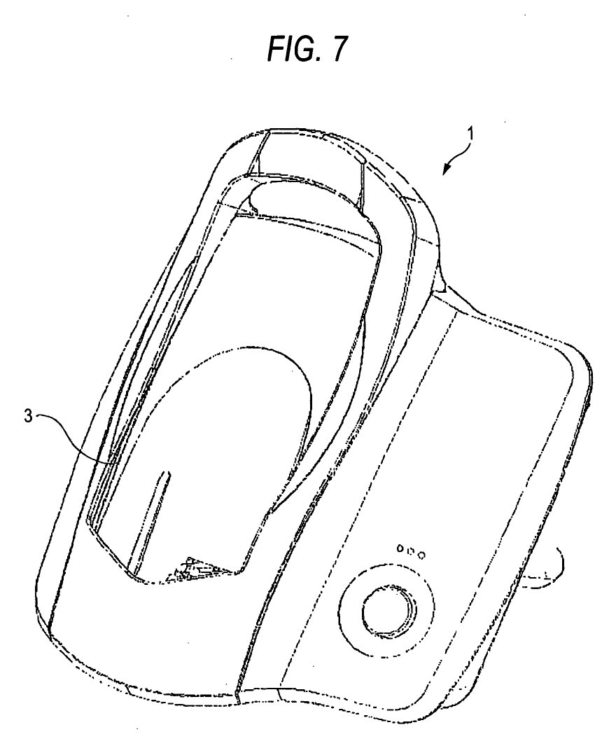

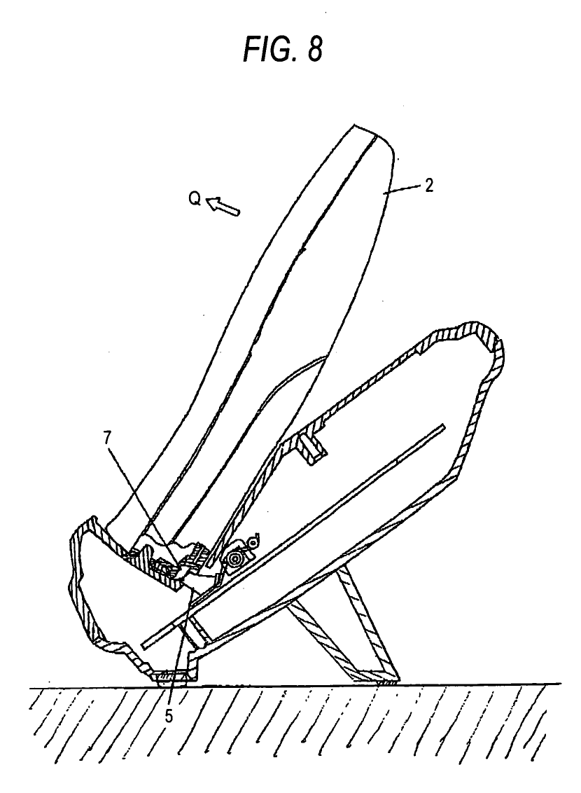

Furthermore, as shown in FIG. 6, such a modify of the first embodiment may be possible, in which the bottom surface 3b of the concave retaining section 3 of the charger base 1 is caused to protrude from the bottom part of the telephone apparatus 2. Or, as shown in FIG. 7, it is possible that a part of the lower part of the opening section of the concave retaining section 3 of the charger base 1 overlaps the lower end of the telephone apparatus 2. The section in this case is shown in FIG. 8. This example is a mode in which the opening section is made open like an inverted triangle. Or, it may be possible that a part of the lower part of the opening section of the concave retaining section 3 of the charger base 1 linearly overlaps the lower end of the telephone apparatus 2.

In this embodiment, since the concave retaining section of the charger base is entirely open at its front side, there is no need to insert the telephone set into the opening section while checking the position of the opening section when placing the telephone set. Therefore, it is possible to easily place the telephone set in the charger base. In addition, although the lower end of the telephone set is inserted into the lower part of the concave retaining section in a state where the lower end of the telephone set inserted toward its front side by a contact load of the power feeding terminal provided at the lower part of the inclined surface, the telephone set is fixed so that the position of the power feeding terminal and the position of the charging terminal provided at the telephone set are stabilized by the positioning member secured at the lower part of the concave retaining section. Therefore, a stabilized charging state can be secured. Further, when using the telephone set, since the telephone set can be pulled out from the opening section in the front surface direction of the charger base, it is not necessary to lift up the telephone set upward along the concave retaining section, wherein removal thereof is made easier. Also, the position where the positioning member is installed, and height thereof are determined by the weight of the telephone set and force a balance at a point where the telephone set is brought into contact with the concave retaining section.

In a case that the telephone set is left in the concave retaining section with the lower end of the telephone set fitted to the inclined surface of the concave retaining section when inserting the telephone set, the telephone set slips down on the inclined surface by its own-weight. And, the lower end of the telephone set is inserted in the lower part of the concave retaining section in a state where the lower end thereof is pushed to the front surface side by a contact load of the power feeding terminal provided at the lower part of the inclined surface. However, the position of the telephone set is fixed by the positioning member provided at the lower part of the concave retaining section so that the position of the power feeding terminal and the position of the charging terminal provided at the telephone set are stabilized. Therefore, it is possible to easily place the telephone set in the charger base, and at the same time, a stabilized charging state can be secured. In addition, when using the telephone set, since the telephone set can be pulled out from the opening section in the front surface direction of the charger base, it is possible to easily take out the telephone set from the charger base. Accordingly, convenience in use can be improved both when charging the telephone set and when using the same.

Furthermore, since the bottom surface 3b of the concave retaining section 3 of the charger base is formed so as to protrude forward, the indication of placing the telephone apparatus 2 in the charger base is made greater, and a user can further easily place the telephone apparatus 2. In addition, since a part of the lower part of the opening section of the concave retaining section 3 of the charger base 1 overlaps the lower end of the telephone apparatus 2, it is possible for a user to place the telephone apparatus 2 not at the forward side of the charger base but at the deep side thereof.

### Second Embodiment

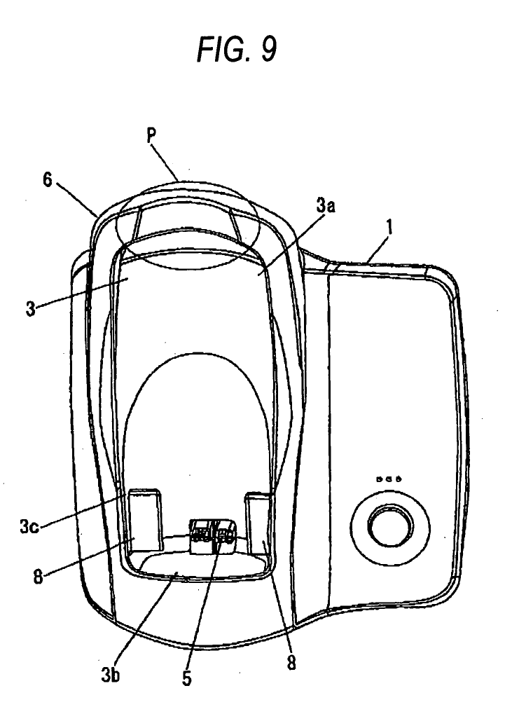

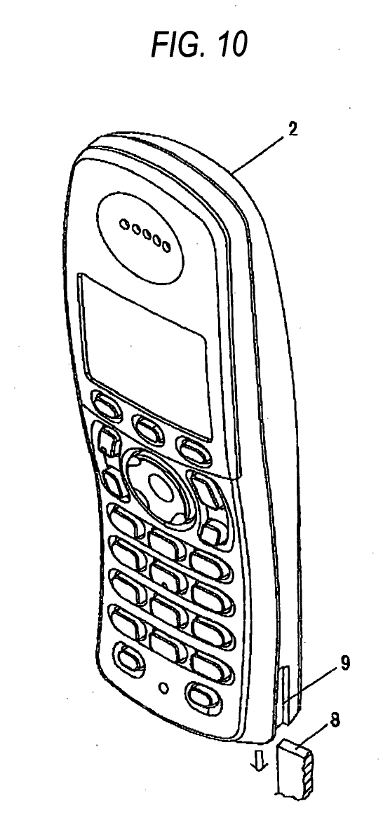

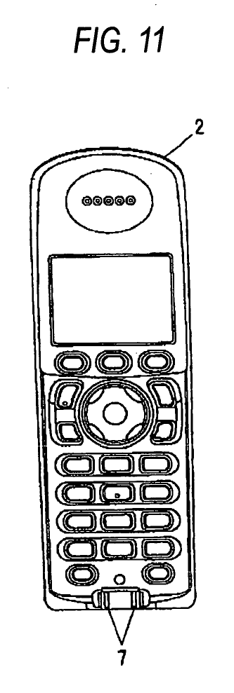

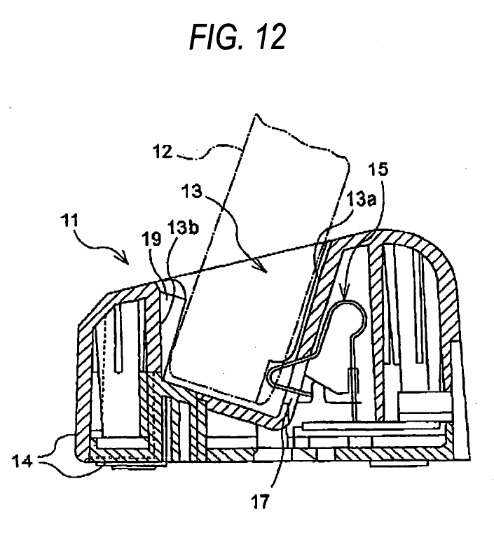

Next, a description is given of a cordless telephone set according to the second embodiment of the present invention, using the drawings. FIG. 9 is a perspective view depicting the concave retaining section of the charger base according to the second embodiment of the present invention, and FIG. 10 is a perspective view of the telephone apparatus. As shown in FIGS. 9 and 10, since the cordless telephone set according to the second embodiment of the present invention is the same as a cordless telephone set according to the first embodiment, excepting a rib, which is a type of the projection serving as the positioning member provided in the concave retaining section, and a recessed section of the telephone apparatus which is provided so as to correspond to the rib. The components that are identical to those of the first embodiment are given the same reference numerals, and description therecf is omitted.

A rib 8, which is a type of the projection serving as a member for positioning the telephone apparatus 2, is provided at both sides 3c of the lower end of the concave retaining section 3 of the cordless telephone set according to the second embodiment of the present invention, respectively. Also, a recessed section 9 is provided at the position corresponding to the rib 8 at both sides of the lower end of the telephone apparatus 2, respectively. Since the rib 8 is fitted in the recessed section 9 when the telephone apparatus 2 is placed in the charger base 1, the telephone set is positioned in the forward and rearward direction.

With this construction, actions and effects which are similar to those of the first embodiment can be brought about with respect to placing a telephone set in a charger base 1 and removal therefrom according to the second embodiment of the present invention. Therefore, a cordless telephone set according to the second embodiment of the present invention is able to improve convenience in use both when charging the telephone set and when using the same.

Although a rib 8 is formed as a projection which serves as a positioning member in the second embodiment according to the present invention, the projection is not limited thereto, but the projection may be of any shape as long as the telephone apparatus 2 is fixed so that the power feeding terminal 5 provided at the inclined surface 3a and the charging terminal 7 secured at the telephone apparatus 2 are not separated from each other. However, if the telephone set can be fixed at a predetermined position, it is preferable that the projection is made as small as possible.

Although the charging terminal 7 is provided at the lower part of the rear side of the telephone apparatus 2 in the cordless telephone apparatus 2 according to the first and second embodiments of the present invention, the charging terminal 7 may separately be provided at the lower part of the front side of the telephone apparatus 2. In this case, the front side of the telephone apparatus 2 is placed so as to be faced to the inclined surface 3a side of the concave retaining section 3 of the charger base 1.

In addition, although the inclined surface 3a of the concave retaining section 3 of the cordless telephone set according to the first and second embodiments of the present invention has a curved shape corresponding to the shape of the telephone apparatus 2, the inclined surface 3a is not limited thereto. The inclined surface 3a may be a plain shape. Although the inclined surface 3a of the concave retaining section 3 and the side surface 3c are formed as separate planes, these are not limited thereto. The inclined surface 3a and the side surface 3c may be composed of a semicircular curved surface which is not clearly separate. In this case, a projection may be provided at the lower part of the curved surface.

Since the present invention secures a stabilized charging state and makes it easy to place a telephone set and to take it out, the present invention is effective for a cordless telephone set including a charger base having a power feeding function and a child set having a charging function.

The present application is based on Japan Patent Application No. 2004-299894 filed on Oct. 14, 2004, the contents of which are incorporated herein for reference.

What is claimed is:

1 A cordless telephone set, comprising:
a charger base that includes a concave retaining section and a power feeding terminal for feeding power; and
a telephone apparatus to be placed in the concave retaining section,
wherein the concave retaining section has an inclined surface for supporting the telephone apparatus and an open section that opens across the entire surface at a front side of the inclined surface;
wherein a charging terminal is disposed at a lower end of a rear face of the telephone apparatus;
wherein the power feeding terminal for contacting with the charging terminal of the telephone apparatus is provided on a lower part of the inclined surface at a lower part of the concave retaining section;
wherein a positioning member for restraining the telephone apparatus is provided at the lower part of the concave retaining section, the positioning member being located in front of the power feeding terminal on the charger base; and
wherein a first distance between a support point at which the positioning member supports the telephone apparatus and a center of gravity of the telephone apparatus is in a positional relationship greater by a plurality of times than a second distance between the support point and a contact point where the charging terminal of the telephone apparatus is brought into contact with the power feeding terminal on the charger base.

2. The cordless telephone set according to claim 1, wherein the inclined surface has an inclination angle by which the telephone apparatus is slipped down by its own-weight.

3. The cordless telephone set according to claim 1, wherein the positioning member is a projection provided on a bottom surface of the concave retaining section with which a bottom surface of the telephone apparatus is brought into contact; and
wherein a recessed portion that is engaged with the projection is provided at the bottom surface of the telephone apparatus.

4. The cordless telephone set according to claim 1, wherein the positioning member is a projection provided on a side surface of the concave retaining section with which a side surface of the telephone apparatus is brought into contact; and
wherein a recessed portion that is engaged with the projection is provided at the side surface of the telephone apparatus.

5. A cordless telephone set, comprising:
a charger base that includes a concave retaining section and a power feeding terminal for feeding power; and
a telephone apparatus to be placed in the concave retaining section,
wherein the concave retaining section has an inclined surface for supporting the telephone apparatus and an open section that opens across the entire surface at a front side of the inclined surface;
wherein the power feeding terminal is provided on a lower part of the concave retaining section of the charger base;
wherein a positioning member for restraining the telephone apparatus is provided at the lower part of the concave retaining section, the positioning member being located in front of the power feeding terminal on the charger base;
wherein a charging terminal for contacting with the power feeding terminal is disposed at a lower end of a rear face of the telephone apparatus;
wherein a point at which,the positioning member supports the telephone apparatus is defined as a support point P a point where the charging terminal of the telephone apparatus is brought into contact with the power feeding terminal on the charger base is defined as a contact point C, and a point of the center of gravity of the telephone apparatus is defined as a gravity point G;
wherein a first distance between the support point P and the gravity point G of the telephone apparatus is in a positional relationship greater by a plurality of times than a second distance between the support point P and the contact point C; and
wherein when the telephone apparatus is placed on the charger base, the telephone apparatus takes a posture inclined rearward, and the gravity point G of the telephone apparatus is brought further closer to the charger base than the positions of the support point P and the contact point C.
